(19) United States
(12) Patent Application Publication
(10) Pub. No.: US 2026/0166975 A1
(43) Pub. Date: Jun. 18, 2026

(54) GLASS RUN

(71) Applicant: TOYODA GOSEI CO., LTD., Kiyosu-shi (JP)

(72) Inventors: Masatoshi Nojiri, Kiyosu-shi (JP); Tsubasa Shinoda, Kiyosu-shi (JP)

(21) Appl. No.: 19/392,511

(22) Filed: Nov. 18, 2025

(30) Foreign Application Priority Data
Dec. 17, 2024 (JP) 2024-220565

(51) Int. Cl. B60J 10/76; B60J 1/17; B60J 10/16; B60J 10/22; B60J 10/277

(52) U.S. Cl. CPC B60J 10/76; B60J 1/17; B60J 10/16; B60J 10/22; B60J 10/277

(57) ABSTRACT

A vehicle outer hard portion having a hardness higher than that of a vehicle outer side wall is formed on a vehicle outer side wall, a first vehicle inner seal lip that extends toward a vehicle outer side and toward a bottom wall side and is in sliding contact with a door glass is formed on the vehicle inner side wall, a vehicle inner hard portion having a hardness higher than that of the vehicle inner side wall is formed on the vehicle inner side wall, a seal lip side hard portion having a hardness higher than that of the first vehicle inner seal lip is formed on the vehicle outer side of the vehicle inner hard portion, between the vehicle outer side of the vehicle inner side wall and the first vehicle inner seal lip, and the seal lip side hard portion is formed to come into contact with the first vehicle inner seal lip when the door glass is closed.

### CROSS REFERENCE TO RELATED APPLICATION

This application claims the priority benefit of Japanese Patent Application No. 2024-220565 filed on Dec. 17, 2024. The entirely of the above-mentioned patent application is hereby incorporated by reference herein and made a part of this application.

### BACKGROUND OF THE INVENTION

### (1) Field of the Invention

The present invention relates to a glass run attached to a door of a vehicle such as an automobile.

### (2) Description of Related Art

Improving quietness of vehicles such as automobiles enhances the comfort of occupants and therefore serves as a strong appeal point for improving product value. Further, in electric vehicles, which are becoming increasingly widespread, the conventional engine is no longer installed, and with the elimination of engine noise, the primary remaining noises that become noticeable are road noise and wind noise. Therefore, there is an increasing need for these reduction techniques.

For example, there is known a technique of reducing vibration by using impedance matching that brings the impedance of a glass run close to the impedance of glass by increasing the rigidity of the glass run (for example, Japanese Patent Application Laid-Open No. 2023-53894).

FIG. 11 illustrates a technique disclosed in Japanese Patent Application Laid-Open No. 2023-53894. A glass run 100 includes a bottom wall 200, a vehicle outer side wall 300, and a vehicle inner side wall 400 as its basic structure. The basic structure is attached to a door frame groove portion 500 formed in a door frame 310 and guides the raising and lowering of a door glass 600. On the vehicle inner side of the vehicle outer side wall 300, a thick portion 330 having a hardness higher than that of the vehicle outer side wall main body portion 320 of the vehicle outer side wall 300 is formed so as to protrude toward the vehicle inner side and come into sliding contact with the door glass 600.

When the thick portion 330 having high hardness comes into contact with the door glass 600, vibration can be reduced by efficiently transmitting the vibration of the door glass 600 to the glass run 100 through impedance matching.

Further, by bringing the vehicle outer side wall 300, on which the thick portion 330 having high hardness is formed, into contact with the door frame groove portion 500 to form a structure in which the door glass 600 and the door frame groove portion 500 sandwich the vehicle outer side wall 300 including the thick portion 330, it is also possible to increase the rigidity of the vehicle outer side wall 300 with respect to the door glass 600 and the door frame groove portion 500 and reduce vibration through impedance matching.

### SUMMARY OF THE INVENTION

In a vehicle such as an automobile, the door frame 310 (a door frame groove portion 500 formed inside the door frame 310) is curved in the vertical and longitudinal directions of the vehicle. Further, the door glass 600 is also curved in the vertical and longitudinal directions of the vehicle. The degree of curvature of the door frame 310 (door frame groove portion 500) and that of the door glass 600 are different.

A glass run that is formed into an approximately linear shape has flexibility due to the softness of its material and thus exhibits followability to the door frame. However, in the glass run 100 having the thick portion 330 with high hardness formed thereon, variations in the curvature of the door glass 600 and the door frame 310 (door frame groove portion 500) cause a gap to occur between the thick portion 330 and the door glass 600, particularly in a region from a position slightly before the door glass 600 is fully closed to the position where it is completely closed, near the upper corner portion of the door glass 600.

In the region where this gap occurs, the vibration of the door glass 600 cannot be transmitted to the thick portion 330 (vehicle outer side wall 300) having high hardness. Therefore, the vibration reduction effect utilizing impedance matching is reduced compared with the case where the thick portion 330 is in contact with the door glass 600 over the entire area.

The present invention provides a glass run that can sufficiently exhibit the vibration reduction effect utilizing impedance matching even when a gap occurs between the vehicle outer side wall and the door glass due to variations in the curvature of the door glass or the door frame.

In order to solve the above problems, a first aspect of the present invention is a glass run including a bottom wall, a vehicle outer side wall, and a vehicle inner side wall, in which a vehicle outer hard portion having a hardness higher than that of the vehicle outer side wall is formed on the vehicle outer side wall, a vehicle inner hard portion having a hardness higher than that of the vehicle inner side wall is formed on the vehicle inner side wall, a vehicle inner seal lip that extends toward the vehicle outer side and toward the bottom wall side and is in sliding contact with the door glass is formed on the vehicle inner side wall, a seal lip side hard portion having a hardness higher than that of the vehicle inner seal lip is formed between the vehicle outer side of the vehicle inner side wall and the vehicle inner seal lip, on the vehicle inner side of the vehicle inner seal lip or on the vehicle outer side of the vehicle inner side wall, in a case where the seal lip side hard portion is formed on the vehicle inner seal lip, the seal lip side hard portion is in contact with the vehicle inner side wall at least when the door glass is closed, and in a case where the seal lip side hard portion is formed on the vehicle inner side wall, the seal lip side hard portion is in contact with the vehicle inner seal lip at least when the door glass is closed.

In the first aspect of the present invention, a vehicle inner seal lip that extends toward the vehicle outer side and toward the bottom wall side and is in sliding contact with the door glass is formed on the vehicle inner side wall, and a vehicle inner hard portion having a hardness higher than that of the vehicle inner side wall is formed on the vehicle inner side wall, a seal lip side hard portion having a hardness higher than that of the vehicle inner seal lip is formed between the vehicle outer side of the vehicle inner side wall and the seal lip, on the vehicle inner side of the vehicle inner seal lip or on the vehicle outer side of the vehicle inner side wall, in a case where the seal lip side hard portion is formed on the vehicle inner seal lip, the seal lip side hard portion comes into contact with the vehicle inner side wall at least when the door glass is closed, and in a case where the seal lip side hard portion is formed on the vehicle inner side wall, the seal lip side hard portion comes into contact with the vehicle inner seal lip at least when the door glass is closed, and thus, even in a region where a gap occurs between the vehicle outer side wall and the door glass, such as the region where the above described problem occurs, the contact among the door glass, the vehicle inner seal lip, the seal lip side hard portion, and the vehicle inner side wall (vehicle inner hard portion) increases the rigidity on the vehicle inner side of the vehicle inner seal lip, thereby allowing the vibration of the door glass to be transmitted to the glass run on the vehicle inner side of the door glass. Further, the vibration can be transmitted to the door side to which the glass run is attached. As a result, the effect of reducing the vibration by utilizing impedance matching can be sufficiently exhibited over the entire region of the glass run.

The vehicle inner hard portion formed in the vehicle inner side wall may be formed to be exposed on the vehicle outer side of the vehicle inner side wall, or may be formed inside the vehicle inner side wall.

In a case where the vehicle inner hard portion is formed to be exposed on the vehicle outer side of the vehicle inner side wall, it is desirable, from the viewpoint of increasing the rigidity on the glass run side constituted by the vehicle inner seal lip, the seal lip side hard portion, the vehicle inner hard portion, and the vehicle inner side wall, that the seal lip side hard portion and the vehicle inner hard portion come into contact with each other.

Further, in a case where the vehicle inner hard portion is formed inside the vehicle inner side wall, it is desirable, from the viewpoint of increasing the rigidity on the glass run side constituted by the vehicle inner seal lip, the seal lip side hard portion, and the vehicle inner side wall (vehicle inner hard portion), that the seal lip side hard portion comes into contact with the vehicle inner side wall in a region where the vehicle inner hard portion is formed.

Further, the vehicle inner hard portion formed in the vehicle inner side wall may also be formed to penetrate from the vehicle outer side to the vehicle inner side of the vehicle inner side wall. For example, it may be exposed on both the vehicle outer side and the vehicle inner side of the vehicle inner side wall and formed as separated portions.

A second aspect of the present invention is the glass run according to the first aspect, in which the hardness of the seal lip side hard portion is the same as that of the vehicle inner hard portion, or is between the hardness of the vehicle inner seal lip and that of the vehicle inner hard portion.

In the second aspect of the present invention, since the hardness of the seal lip side hard portion is the same as that of the vehicle inner hard portion or is between the hardness of the vehicle inner seal lip and that of the vehicle inner hard portion, the contact between the door glass, the vehicle inner seal lip, the seal lip side hard portion, the vehicle inner side wall (the vehicle inner hard portion), and the door increases the rigidity from the vehicle inner seal lip to the vehicle inner side wall (the vehicle inner hard portion) in the glass run, thereby allowing the vibration of the door glass to be transmitted to the glass run. As a result, the effect of reducing the vibration by utilizing impedance matching can be sufficiently exhibited.

A third aspect of the present invention is the glass run according to the first aspect, in which the seal lip side hard portion is formed in a region where, when the door glass is closed, the vehicle outer side of the door glass and the vehicle outer hard portion do not come into contact with each other, or, in a case where a vehicle outer seal lip that extends toward the vehicle inner side and toward the bottom wall side and is in sliding contact with the door glass is formed on the vehicle outer side wall and the vehicle outer seal lip and the vehicle outer hard portion are contactable, the seal lip side hard portion is formed in a region where the vehicle outer seal lip and the vehicle outer hard portion do not come into contact with each other.

Here, the region where the vehicle outer side of the door glass and the vehicle outer hard portion do not come into contact with each other, and the region where the vehicle outer seal lip and the vehicle outer hard portion do not come into contact with each other include the portion of the vehicle outer side wall in which the vehicle outer hard portion is formed when the vehicle outer hard portion is formed inside the vehicle outer side wall.

In the third aspect of the present invention, the seal lip side hard portion is formed in a region where, when the door glass is closed, the vehicle outer side of the door glass and the vehicle outer hard portion do not come into contact with each other, or, in a case where a vehicle outer seal lip that extends toward the vehicle inner side and toward the bottom wall side and is in sliding contact with the door glass is formed on the vehicle outer side wall and the vehicle outer seal lip and the vehicle outer hard portion are contactable, in a region where the vehicle outer seal lip and the vehicle outer hard portion do not come into contact with each other, that is, in a region where a gap is generated as pointed out in the above-described problem. Therefore, compared to a case where the seal lip side hard portion is formed over the entire area, including a region where no gap is generated, the glass run can be reduced in weight.

A fourth aspect of the present invention is the glass run according to the third aspect, in which the seal lip side hard portion is formed by being attached to the vehicle inner seal lip or the vehicle inner side wall.

In the fourth aspect of the present invention, since the seal lip side hard portion is formed by being attached to the vehicle inner seal lip or the vehicle inner side wall, it is retrofitted to the glass run after extrusion molding of the cross section in which the seal lip side hard portion is not formed. As a result, the molding of the glass run becomes easier compared to extrusion molding in which the seal lip side hard portion is formed in a region where the vehicle outer side of the door glass and the vehicle outer side wall do not come into contact with each other. Accordingly, this aspect is useful for extrusion molding of the glass run.

Further, since forming the seal lip side hard portion by attaching it to the vehicle inner seal lip or the vehicle inner side wall allows easy adaptation to differences in the curvature of door frames and door glasses among different vehicle models, a glass run having a cross section in which the seal lip side hard portion is not formed can also be applied to other vehicle models.

A fifth aspect of the present invention is a glass run including a bottom wall, a vehicle outer side wall, and a vehicle inner side wall, in which a vehicle outer hard portion having a hardness higher than that of the vehicle outer side wall is formed on the vehicle outer side wall, a vehicle inner hard portion having a hardness higher than that of the vehicle inner side wall is formed on the vehicle inner side wall, a vehicle inner seal lip that extends toward the vehicle outer side and toward the bottom wall side and has a tip end portion curved toward the vehicle inner side wall is formed on the vehicle inner side wall, the vehicle inner seal lip includes a side wall side portion connected to the vehicle inner side wall and a seal lip hard portion having a hardness higher than that of the side wall side portion and connected to the side wall side portion, and the seal lip hard portion is in contact with the door glass and the vehicle inner side wall at least when the door glass is closed.

In the fifth aspect of the present invention, a vehicle inner seal lip that extends toward the vehicle outer side and toward the bottom wall side and has a tip end portion curved toward the vehicle inner side wall is formed on the vehicle inner side wall. The vehicle inner seal lip includes a side wall side portion connected to the vehicle inner side wall and a seal lip hard portion having a hardness higher than that of the side wall side portion and connected to the side wall side portion. Since the seal lip hard portion comes into contact with the door glass and the vehicle inner side wall at least when the door glass is closed, even in a region where a gap occurs between the vehicle outer side wall and the door glass, such as the region identified as problematic above, the vibration of the door glass can be transmitted to the glass run through the contact between the door glass, the seal lip hard portion, and the vehicle inner side wall (vehicle inner hard portion). Further, the vibration can be transmitted to the door side to which the glass run is attached. As a result, the effect of reducing the vibration by utilizing impedance matching can be sufficiently exhibited over the entire region of the glass run.

The vehicle inner hard portion formed in the vehicle inner side wall may be formed to be exposed on the vehicle outer side of the vehicle inner side wall, or may be formed inside the vehicle inner side wall.

In a case where the vehicle inner hard portion is formed to be exposed on the vehicle outer side of the vehicle inner side wall, it is desirable, from the viewpoint of increasing the rigidity on the glass run side constituted by the seal lip hard portion, the vehicle inner hard portion, and the vehicle inner side wall, that the seal lip hard portion and the vehicle inner hard portion come into contact with each other.

Further, in a case where the vehicle inner hard portion is formed inside the vehicle inner side wall, it is desirable, from the viewpoint of increasing the rigidity on the glass run side constituted by the seal lip hard portion and the vehicle inner side wall (vehicle inner hard portion), that the seal lip hard portion comes into contact with the vehicle inner side wall in a region where the vehicle inner hard portion is formed.

Further, the vehicle inner hard portion formed in the vehicle inner side wall may also be formed to penetrate from the vehicle outer side to the vehicle inner side of the vehicle inner side wall. For example, it may be exposed on both the vehicle outer side and the vehicle inner side of the vehicle inner side wall and formed as separated portions.

A sixth aspect of the present invention is the glass run according to the fifth aspect, in which the hardness of the seal lip hard portion is the same as that of the vehicle inner hard portion, or is between the hardness of the side wall side portion of the vehicle inner seal lip and that of the vehicle inner hard portion.

In the sixth aspect of the present invention, since the hardness of the seal lip hard portion is the same as that of the vehicle inner hard portion, or is between the hardness of the side wall side portion of the vehicle inner seal lip and that of the vehicle inner hard portion, vibration of the door glass can be transmitted to the seal lip hard portion by the contact between the door glass and the seal lip hard portion through impedance matching. In addition, the vibration of the door glass can be transmitted to the vehicle inner side wall by the contact between the seal lip hard portion and the vehicle inner side wall (vehicle inner hard portion). As a result, the effect of reducing the vibration by utilizing impedance matching can be sufficiently exhibited over the entire region of the glass run.

A seventh aspect of the present invention is the glass run according to the fifth aspect, in which a thin bend-base portion having a reduced thickness is formed in the vicinity of a connecting portion between the seal lip hard portion and the side wall side portion of the vehicle inner seal lip.

In the seventh aspect of the present invention, since a thin bend-base portion having a reduced thickness is formed in the vicinity of a connecting portion between the side wall side portion of the vehicle inner seal lip and the seal lip hard portion, the seal lip hard portion comes into contact with the vehicle inner side wall (vehicle inner hard portion), and further, in a region where the door glass is positioned on the vehicle inner side, the side wall side portion deforms at the bend-base portion, whereby, the pressing force with which the seal lip hard portion pushes the door glass toward the vehicle outer side can be reduced. As a result, it is possible to prevent any adverse effect on the sliding of the door glass.

According to an eighth aspect of the present invention, in the seventh aspect, the bend-base portion is formed on the vehicle inner side of the side wall side portion.

In the eighth aspect of the present invention, since the bend-base portion is formed on the vehicle inner side of the side wall side portion, the side wall side portion is easily deformed at the bend-base portion. As a result, since the pressing force with which the seal lip hard portion pushes the door glass toward the vehicle outer side can be reduced, it is possible to prevent any adverse effect on the sliding of the door glass.

### BRIEF DESCRIPTION OF THE DRAWINGS

FIG. 1 is a front view of an automobile door;

FIG. 2 is a front view illustrating a glass run used for a door frame of FIG. 1;

FIG. 3 is a cross-sectional view taken along line A-A of FIG. 1 according to a first embodiment of the present invention;

FIG. 4 is a cross-sectional view taken along line A-A of FIG. 1 according to a second embodiment of the present invention;

FIG. 5 is a cross-sectional view taken along line B-B of FIG. 1 according to a third embodiment of the present invention;

FIG. 6 is a cross-sectional view taken along line B-B of FIG. 1 according to a fourth embodiment of the present invention;

FIG. 7 is a cross-sectional view taken along line C-C of FIG. 1 according to a fifth embodiment of the present invention;

FIG. 8 is a cross-sectional view taken along line A-A of FIG. 1 according to a sixth embodiment of the present invention;

FIG. 9 is a cross-sectional view taken along line B-B of FIG. 1 according to a seventh embodiment of the present invention;

FIG. 10 is a cross-sectional view taken along line C-C of FIG. 1 according to an eighth embodiment of the present invention; and

FIG. 11 is a cross-sectional view illustrating an attachment structure of a conventional glass run (Japanese Patent Application Laid-Open No. 2023-53894).

### DETAILED DESCRIPTION OF PREFERRED EMBODIMENTS

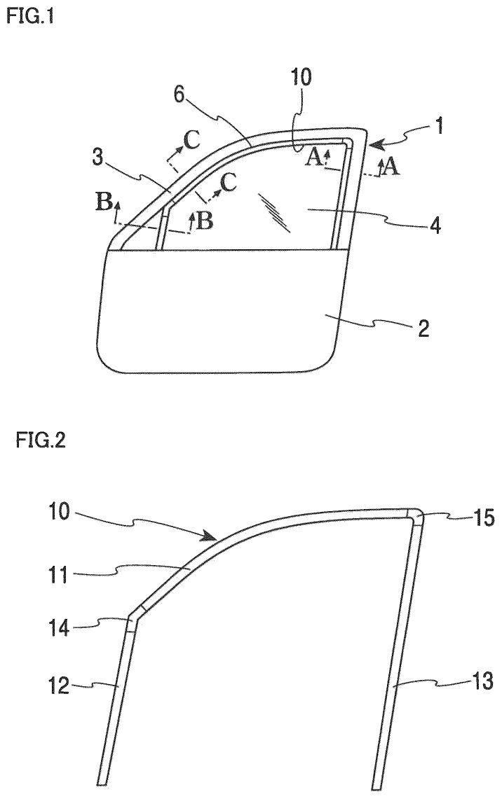

A first embodiment of the present invention will be described with reference to FIGS. 1 to 3. FIG. 1 is a front view of a left front door 1 of an automobile as viewed from a vehicle outer side. A door frame 3 is mounted on an upper portion of a door main body 2 that constitutes the front door 1. A window opening is formed by the door frame 3 and an upper edge of the door main body 2. A glass run 10 is attached to a door frame groove portion 6 formed in the door frame 3 and to an inside of the door main body 2 to guide the vertical movement of a door glass 4. It should be noted that the present invention is applicable not only to the left front door 1, but also to a right front door and right and left rear doors. Further, it can also be applied to a sliding door in which the door glass moves up and down.

FIG. 2 is a simplified front view of only the glass run 10 as viewed from the vehicle outer side. The glass run 10 is composed of a first extrusion portion 11 corresponding to a horizontal frame portion of the door frame 3, a second extrusion portion 12 corresponding to a front vertical frame portion of the front door 1, and a third extrusion portion 13 corresponding to a rear vertical frame portion. The front end portion of the first extrusion portion 11 is connected to an upper end portion of the second extrusion portion 12 by a first molded portion 14. Further, the rear end portion of the first extrusion portion 11 is connected to an upper end portion of the third extrusion portion 13 by a second molded portion 15. FIGS. 1 and 2 are also used for second to eighth embodiments described later.

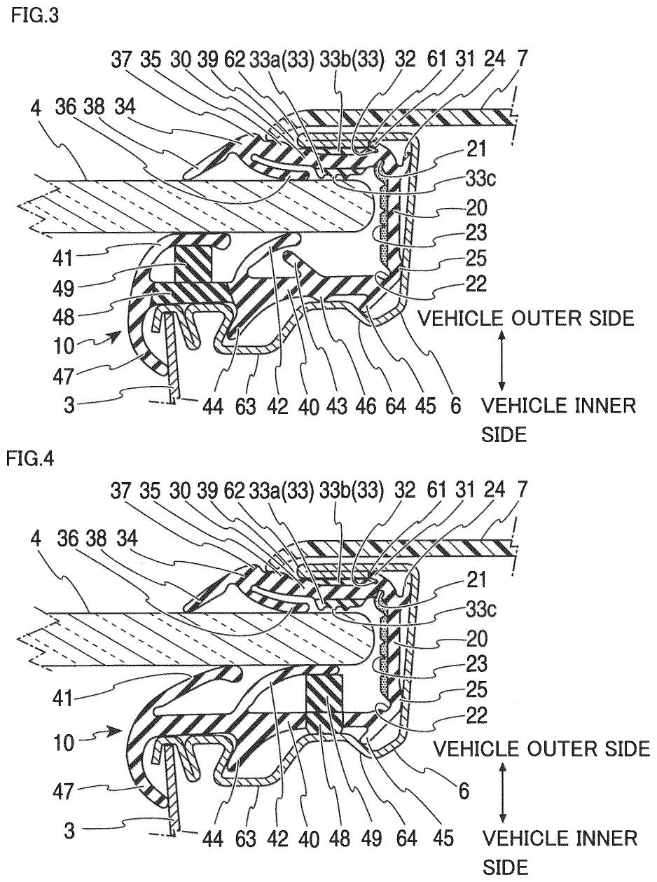

FIG. 3 is a sectional view taken along line A-A of FIG. 1 and illustrates a cross section when the glass run 10 is attached to the door frame groove portion 6 of the door frame 3 and the door glass 4 is closed. Further, this position corresponds to the third extrusion portion 13 in the vicinity of the second molded portion 15, which is a region where a gap occurs between the door glass 4 and a vehicle outer hard portion 33 described later. The glass run 10 includes a bottom wall 20, a vehicle outer side wall 30, and a vehicle inner side wall 40. Further, the vehicle inner side wall 40 is formed larger than the vehicle outer side wall 30, and its shape is asymmetrical with the vehicle inner side being larger.

At a connecting portion between the bottom wall 20 and the vehicle outer side wall 30, a vehicle outer groove portion 21 is formed, and at a connecting portion between the bottom wall 20 and the vehicle inner side wall 40, a vehicle inner groove portion 22 is formed. Here, the vehicle inner groove portion 22 is formed thicker than the vehicle outer groove portion 21. Further, in order to make the vehicle inner groove portion 22 thicker, a projecting portion 25 protruding from the bottom wall 20 is formed on a side opposite to the vehicle inner groove portion 22. The projecting portion 25 may be omitted as long as the thickness of the vehicle inner groove portion 22 is ensured.

The bottom wall 20 is formed in a substantially plate shape, and on an inner surface (the door glass 4 side) of the bottom wall 20, a plurality of concave portions 23 of the bottom wall are continuously and parallelly formed in a longitudinal direction. Further, on an outer surface of the bottom wall 20, a bottom wall seal lip 24 is formed.

On the vehicle outer side of the vehicle outer side wall 30, a vehicle outer holding lip 31 extending toward the vehicle outer side wall 30 in the tip end portion direction is formed in the vicinity of the connecting portion with the bottom wall 20. Further, at a base portion of the vehicle outer holding lip 31 of the vehicle outer side wall 30, a thin-walled portion 32 having a reduced thickness is formed.

A vehicle outer hard portion 33 having a hardness higher than that of a material constituting the vehicle outer side wall 30 is formed on the vehicle inner side of the vehicle outer side wall 30. Further, the vehicle outer hard portion 33 is divided into a hard portion vehicle inner portion 33a formed on the vehicle inner side of the vehicle outer side wall 30, and a hard portion vehicle outer portion 33b formed on the vehicle outer side and is formed. The hard portion vehicle inner portion 33a projects from the vehicle outer side wall 30 toward the vehicle inner side and is formed. On the other hand, the hard portion vehicle outer portion 33b, which is formed on the vehicle outer side, is located inside the vehicle outer side wall 30 and is formed to be exposed on the vehicle outer side of the vehicle outer side wall 30. Further, the hard portion vehicle outer portion 33b is formed at a position facing the hard portion vehicle inner portion 33a.

On the vehicle inner surface of the hard portion vehicle inner portion 33a, a plurality of convex ribs 33c are formed continuously and in parallel in the longitudinal direction.

The vehicle outer hard portion 33 may be formed without being divided into the hard portion vehicle inner portion 33a and the hard portion vehicle outer portion 33b, and may consist only the hard portion vehicle inner portion 33a, or may be formed to penetrate from the vehicle inner side to the vehicle outer side.

The hard portion vehicle outer portion 33b is not formed in the thin-walled portion 32. The hard portion vehicle outer portion 33b is formed in a direction toward a tip end portion 34 of the vehicle outer side wall 30 from the thin-walled portion 32.

In the vehicle outer side wall 30, a stepped portion 35 having an increased thickness is formed in a direction toward the tip end portion 34 from the hard portion vehicle outer portion 33b.

The vehicle outer seal lip 36 is formed from the tip end portion 34 of the vehicle outer side wall 30 in the direction toward the vehicle inner side and the bottom wall 20 side. In the present embodiment, the vehicle outer seal lip 36 does not come into contact with the hard portion vehicle inner portion 33a. Further, a holding rib 37 is formed on the vehicle outer side of the tip end portion 34 of the vehicle outer side wall 30. Further, on the tip end side from the base portion of the vehicle outer seal lip 36 of the vehicle outer side wall 30, a vehicle outer cover lip 38 is formed in the direction toward the vehicle inner side and in the direction opposite to the bottom wall 20.

On the vehicle outer side of the vehicle inner side wall 40, a first vehicle inner seal lip 41 is formed to extend from the tip end portion of the vehicle inner side wall 40 toward the vehicle outer side and the bottom wall 20 side. Further, between the first vehicle inner seal lip 41 and the bottom wall 20, and extending toward the bottom wall 20 side, a second vehicle inner seal lip 42 is formed. Further, on the vehicle outer surface of the vehicle inner side wall 40, on the bottom wall 20 side of the second vehicle inner seal lip 42, a sub-lip 43 is formed to extend toward the vehicle outer side and in the direction opposite to the bottom wall 20. The sub-lip 43 may be formed to extend toward the bottom wall 20 side. Furthermore, the sub-lip 43 may not be formed.

Further, on the vehicle inner side of the vehicle inner side wall 40, a second vehicle inner holding lip 45 is formed in the vicinity of the connecting portion with the bottom wall 20, extending toward the tip end portion of the vehicle inner side wall 40. A first vehicle inner holding lip 44 is formed to extend toward the tip end portion of the vehicle inner side wall 40 from between the second vehicle inner holding lip 45 and the tip end portion of the vehicle inner side wall 40. Further, between the first vehicle inner holding lip 44 and the second vehicle inner holding lip 45, a contact rib 46 is formed.

From the tip end portion of the vehicle inner side wall 40, a vehicle inner cover lip 47 is formed to extend toward the vehicle inner side and toward the bottom wall 20 side.

In the vehicle inner side wall 40, in a region extending from the bottom wall 20 side of the base portion of the first vehicle inner seal lip 41 to the first vehicle inner seal lip 41 side of the base portion of the second vehicle inner seal lip 42, a vehicle inner hard portion 48 having a hardness higher than that of the material constituting the vehicle inner side wall 40 is formed to penetrate from the vehicle outer side to the vehicle inner side.

The vehicle inner hard portion 48 may not penetrate from the vehicle outer side to the vehicle inner side, and, similarly to the above-described vehicle outer hard portion 33, may be divided into a vehicle outer side and a vehicle inner side and is formed. Further, it may also be formed inside the vehicle inner side wall 40.

On the vehicle outer side of the vehicle inner hard portion 48, a seal lip side hard portion 49 having a hardness higher than that of the material constituting the first vehicle inner seal lip 41 is formed. In the present embodiment, the seal lip side hard portion 49 was formed from the same material as that of the vehicle inner hard portion 48 in terms of hardness. Further, the vehicle inner hard portion 48 was formed from the same material as that of the vehicle outer hard portion 33 in terms of hardness. The hardness of the seal lip side hard portion 49, the hardness of the vehicle inner hard portion 48, and the hardness of the vehicle outer hard portion 33 do not necessarily have to be the same.

Further, the seal lip side hard portion 49 was formed by adhesion to be attached onto the vehicle outer surface of the vehicle inner hard portion 48. It is also possible to attach it by other methods such as welding.

The seal lip side hard portion 49 was formed in a region, in the longitudinal direction of the third extrusion portion 13, where a gap is generated between the door glass 4 and the vehicle outer hard portion 33 when the door glass 4 is closed. In this case, from the viewpoint of the sliding performance of the door glass 4, it is preferable that the seal lip side hard portion 49 be formed to match the shape of the gap between the door glass 4 and the vehicle outer hard portion 33; however, the seal lip side hard portion 49 may be formed to have a constant thickness.

It is desirable that the seal lip side hard portion 49 also be formed in the second molded portion 15. In this case, the seal lip side hard portion 49 is molded at the time of mold forming to match the shape of the gap between the door glass 4 and the vehicle outer hard portion 33, or to have a constant thickness.

In the present embodiment, polypropylene (PP) was used for the vehicle outer hard portion 33, the vehicle inner hard portion 48, and the seal lip side hard portion 49, and the glass run 10 excluding the vehicle outer hard portion 33, the vehicle inner hard portion 48, and the seal lip side hard portion 49 was produced by extrusion molding using an olefin-based thermoplastic elastomer (TPO) having an International Rubber Hardness (IRHD) of 80±5. The vehicle outer hard portion 33, the vehicle inner hard portion 48, and the seal lip side hard portion 49 may be made of the same TPO as the other portions, and in this case, it is preferable that the IRHD be 100±5. Furthermore, a hard resin material other than PP, for example, an olefin-based resin such as polystyrene, may be used.

In FIG. 3, a center pillar 7 is attached on the vehicle outer side of the door frame groove portion 6. The door frame groove portion 6 is made of metal.

When the glass run 10 is attached to the door frame groove portion 6 of the door frame 3, the bottom wall seal lip 24 of the bottom wall 20 elastically contacts the door frame groove portion 6, and the projecting portion 25 comes into contact with the door frame groove portion 6.

On the vehicle outer side wall 30, the vehicle outer holding lip 31 comes into contact with a hemming-processed tip end portion 61 of the door frame groove portion 6 that has been subjected to hemming processing, and the hard portion vehicle outer portion 33b comes into surface contact with the vehicle inner side of the door frame groove portion 6 that has been subjected to hemming processing.

Further, the stepped portion 35 does not contact the bent portion of the hemming processing, that is, a vehicle outer tip end portion 62 of the door frame groove portion 6, and a tip end side gap portion 39 is formed between the stepped portion 35 and the vehicle outer tip end portion 62 of the door frame groove portion 6. Further, the tip end portion of the center pillar 7 comes into contact with the holding rib 37.

On the vehicle outer side of the vehicle inner side wall 40, the vehicle inner side wall 40 and the contact rib 46 come into contact with the door frame groove portion 6, and the first vehicle inner holding lip 44 and the second vehicle inner holding lip 45 come into contact with a first curved portion 63 and a second curved portion 64 of the door frame groove portion 6. Further, the vehicle inner cover lip 47 comes into contact with the door frame 3. Further, the vehicle inner side of the vehicle inner hard portion 48 comes into surface contact with the door frame groove portion 6.

In FIG. 3, the vehicle outer groove portion 21 is deformed such that the vehicle inner side of the vehicle outer side wall 30 approaches the bottom wall 20 very closely, while in the vehicle inner groove portion 22, the vehicle outer side of the vehicle inner side wall 40 and the bottom wall 20 are deformed not to approach each other as closely toward the vehicle outer side, and is attached to the door frame groove portion 6.

When the door glass 4 is inserted between the vehicle outer side wall 30 and the vehicle inner side wall 40, on the vehicle outer side, the vehicle outer cover lip 38 deforms toward the side opposite to the bottom wall 20, and the vehicle outer seal lip 36 deforms toward the bottom wall 20 side and toward the vehicle outer side wall 30 side, and elastically contacts the vehicle outer side of the door glass 4. Further, the vehicle outer side of the door glass 4 comes into contact with the rib 33c formed on the hard portion vehicle inner portion 33a of the vehicle outer hard portion 33.

On the other hand, on the vehicle inner side, the first vehicle inner seal lip 41 and the second vehicle inner seal lip 42 both deform toward the bottom wall 20 side and toward the vehicle inner side wall 40 side, and elastically contact the vehicle inner side of the door glass 4.

When the door glass 4 rises, in a region from a position slightly before the door glass 4 is closed to a position where it is completely closed, due to variations in the curvature of the door frame groove portion 6 (door frame 3) and the door glass 4, as illustrated in FIG. 3, a gap may occur between the rib 33c of the vehicle outer hard portion 33 and the door glass 4.

In a region where a gap is generated between the vehicle outer hard portion 33 and the door glass 4, the door glass 4 is positioned further toward the vehicle inner side as compared with a region where the vehicle outer hard portion 33 and the door glass 4 are in contact. As a result, the first vehicle inner seal lip 41 and the second vehicle inner seal lip 42 both move toward the vehicle inner side wall 40, and the degree of deformation increases. At this time, the seal lip side hard portion 49 formed on the vehicle inner hard portion 48 comes into contact with the first vehicle inner seal lip 41, and the first vehicle inner seal lip 41, the seal lip side hard portion 49, and the vehicle inner hard portion 48 are pressed to be sandwiched between the door glass 4 and the door frame groove portion 6.

Next, a second embodiment of the present invention will be described with reference to FIG. 4. FIG. 4 is a sectional view taken along line A-A of FIG. 1 and illustrates a cross section when the glass run 10 is attached to the door frame groove portion 6 of the door frame 3 and the door glass is closed. Further, this position corresponds to the third extrusion portion 13 in the vicinity of the second molded portion 15, which is a region where a gap occurs between the door glass 4 and a vehicle outer hard portion 33.

The differences between the present second embodiment and the above-described first embodiment are as follows. First, in the vehicle inner side wall 40, the vehicle inner hard portion 48 penetrates from the bottom wall 20 side of the base portion of the second vehicle inner seal lip 42 to a region on the vehicle inner side wall 40 side of the vehicle inner groove portion 22 from the vehicle outer side to the vehicle inner side, and is formed such that it protrudes toward the vehicle inner side. Second, the sub-lip 43 is not formed. The reason why the vehicle inner hard portion 48 is formed such that it protrudes toward the vehicle inner side is based on the fact that, in the above first embodiment, the contact rib 46 is formed.

In a region where a gap is generated between the vehicle outer hard portion 33 and the door glass 4, the door glass 4 is positioned further toward the vehicle inner side as compared with a region where the vehicle outer hard portion 33 and the door glass 4 are in contact. As a result, the first vehicle inner seal lip 41 and the second vehicle inner seal lip 42 both move toward the vehicle inner side wall, and the degree of deformation increases. At this time, the seal lip side hard portion 49 formed on the vehicle inner hard portion 48 comes into contact with the second vehicle inner seal lip 42, and the second vehicle inner seal lip 42, the seal lip side hard portion 49, and the vehicle inner hard portion 48 are pressed to be sandwiched between the door glass 4 and the door frame groove portion 6.

Next, a third embodiment of the present invention will be described with reference to FIG. 5. FIG. 5 is a sectional view taken along line B-B of FIG. 1 and illustrates a cross section when the glass run 10 is attached to the door frame groove portion 6 of the door frame 3 and the door glass is closed. Further, this position corresponds to the second extrusion portion 12 in the vicinity of the first molded portion 14, which is a region where a gap occurs between the door glass 4 and a vehicle outer hard portion 33 described later.

The differences between the present third embodiment and the above-described first embodiment are as follows.

First, in the basic structure, there is no difference in size between the vehicle inner side wall 40 and the vehicle outer side wall 30, and the shape is asymmetrical such that the vehicle inner side is slightly larger. Second, the vehicle outer cover lip 38 is formed on the vehicle outer side wall 30 to extend from the tip end portion 34 of the vehicle outer side wall 30 toward the vehicle outer side and in the direction opposite to the bottom wall 20. Third, in the vehicle inner side wall 40, the vehicle inner hard portion 48 is formed such that it penetrates from the vehicle outer side to the vehicle inner side in a region between the base portion of the second vehicle inner seal lip 42 and the base portion of the sub-lip 43. The seal lip side hard portion 49 is formed on the vehicle inner hard portion 48, which is the same as in the first embodiment.

When the door glass 4 is inserted between the vehicle outer side wall 30 and the vehicle inner side wall 40, in a region where a gap is generated between the vehicle outer hard portion 33 and the door glass 4, the door glass 4 is positioned more toward the vehicle inner side as compared with a region where the vehicle outer hard portion 33 and the door glass 4 are in contact with each other. As a result, the first vehicle inner seal lip 41 and the second vehicle inner seal lip 42 both move toward the vehicle inner side wall, and the degree of deformation increases. At this time, the seal lip side hard portion 49 formed on the vehicle inner hard portion 48 comes into contact with the second vehicle inner seal lip 42, and the second vehicle inner seal lip 42, the seal lip side hard portion 49, and the vehicle inner hard portion 48 are pressed to be sandwiched between the door glass 4 and the door frame groove portion 6.

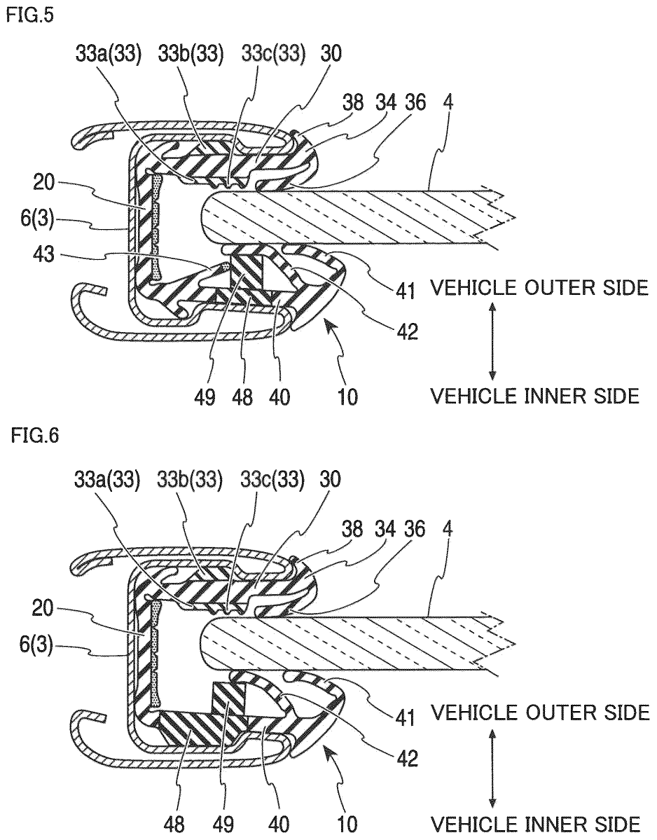

Next, a fourth embodiment of the present invention will be described with reference to FIG. 6. FIG. 6 is a sectional view taken along line B-B of FIG. 1 and illustrates a cross section when the glass run 10 is attached to the door frame groove portion 6 of the door frame 3 and the door glass 4 is closed. Further, this position corresponds to the second extrusion portion 12 in the vicinity of the first molded portion 14, which is a region where a gap occurs between the door glass 4 and a vehicle outer hard portion 33.

The main differences between the present fourth embodiment and the above-described third embodiment are as follows. First, the shape on the vehicle inner side of the door frame groove portion 6 is different, and the region that expands toward the vehicle inner side is larger. Second, corresponding to the difference in the door frame groove portion 6 described above, the vehicle inner side of the vehicle inner hard portion 48 is formed to project beyond the vehicle inner side wall 40. Third, the sub-lip 43 is not present.

When the door glass 4 is inserted between the vehicle outer side wall 30 and the vehicle inner side wall 40, in a region where a gap is generated between the vehicle outer hard portion 33 and the door glass 4, the door glass 4 is positioned more toward the vehicle inner side as compared with a region where the vehicle outer hard portion 33 and the door glass 4 are in contact with each other. As a result, the first vehicle inner seal lip 41 and the second vehicle inner seal lip 42 both move toward the vehicle inner side wall, and the degree of deformation increases. At this time, the seal lip side hard portion 49 formed on the vehicle inner hard portion 48 comes into contact with the second vehicle inner seal lip 42, and the second vehicle inner seal lip 42, the seal lip side hard portion 49, and the vehicle inner hard portion 48 are pressed to be sandwiched between the door glass 4 and the door frame groove portion 6.

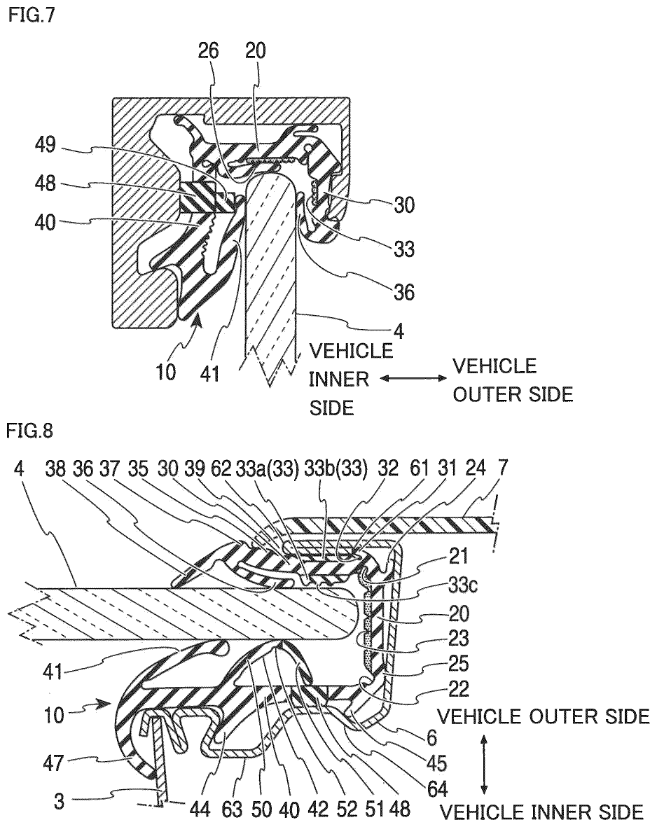

Next, a fifth embodiment of the present invention will be described with reference to FIG. 7. FIG. 7 is a sectional view corresponding to the sectional view taken along line C-C of FIG. 1, and illustrates a cross section when the glass run 10 is attached to a mold having the same shape of the inner surface as the door frame groove portion 6 of the door frame 3, and the door glass 4 is closed. Further, this position corresponds to the first extrusion portion 11 in the vicinity of the first molded portion 14, and is a region where a gap is generated between the vehicle outer seal lip 36 and the vehicle outer hard portion 33.

The main differences between the present fifth embodiment and the above-described first embodiment are as follows. First, in the basic structure, there is no difference in size between the vehicle inner side wall 40 and the vehicle outer side wall 30, and the shape is asymmetrical with the vehicle inner side being slightly larger. Second, a glass-side seal lip 26 is formed on the door glass 4 side of the bottom wall 20. Third, on the vehicle outer side wall 30, the vehicle outer seal lip 36 extending from the tip end portion 34 toward the vehicle inner side and the bottom wall 20 side is contactable with the vehicle outer hard portion 33. Fourth, the vehicle outer hard portion 33 is formed only on the vehicle inner side of the vehicle outer side wall 30. Fifth, in the vehicle inner side wall 40, the second vehicle inner seal lip 42 is not formed.

It is the same that the vehicle inner hard portion 48 is formed to penetrate from the vehicle outer side to the vehicle inner side in a region from the bottom wall 20 side of the base portion of the second vehicle inner seal lip 42 to the vehicle inner side wall 40 side of the vehicle inner groove portion 22. Further, similar to the first embodiment, the vehicle outer hard portion 33 may be formed such that it is divided into the hard portion vehicle inner portion 33a and the hard portion vehicle outer portion 33b, or may be formed to penetrate from the vehicle inner side to the vehicle outer side.

When the door glass 4 is inserted between the vehicle outer side wall 30 and the vehicle inner side wall 40, the vehicle outer seal lip 36 that comes into contact with the door glass 4 is deformed toward the vehicle outer side wall 30 side and comes into contact with the vehicle outer hard portion 33. Accordingly, the vehicle outer seal lip 36, the vehicle outer hard portion 33, and the vehicle outer side wall 30 are pressed to be sandwiched between the door glass 4 and the door frame groove portion 6 (door frame 3).

On the other hand, in the vicinity of the upper corner portion of the door glass 4 illustrated in FIG. 7, in a region from a position slightly before the door glass 4 is closed to the position where it is completely closed, the door glass 4 is positioned more toward the vehicle inner side as compared with a region where the vehicle outer hard portion 33 and the vehicle outer seal lip 36 are in contact with each other. As a result, the vehicle outer seal lip 36 and the vehicle outer hard portion 33 are not in contact with each other. On the other hand, the first vehicle inner seal lip 41 moves in a direction of the vehicle inner side wall 40 direction, and the degree of deformation increases. At this time, the seal lip side hard portion 49 formed on the vehicle inner hard portion 48 comes into contact with the first vehicle inner seal lip 41, and the first vehicle inner seal lip 41, the seal lip side hard portion 49, and the vehicle inner hard portion 48 are pressed to be sandwiched between the door glass 4 and the door frame groove portion 6.

Next, a sixth embodiment of the present invention will be described with reference to FIG. 8. FIG. 8 is a sectional view taken along line A-A of FIG. 1 and illustrates a cross section when the glass run 10 is attached to the door frame groove portion 6 of the door frame 3 and the door glass 4 is closed.

The differences between the present sixth embodiment and the above-described second embodiment are as follows. First, the seal lip side hard portion 49 is not formed. Second, the second vehicle inner seal lip 42 extends toward the vehicle outer side and the bottom wall 20 side, and a tip end portion is curved toward the vehicle inner side wall 40 side. Third, the second vehicle inner seal lip 42 is composed of the side wall side portion 50 connected to the vehicle inner side wall 40, and the seal lip hard portion 51 that is connected to the side wall side portion 50 and has a hardness higher than that of the side wall side portion 50. Fourth, on the vehicle inner side of the side wall side portion 50 in the vicinity of a connecting portion with the seal lip hard portion 51, a thin bend-base portion 52 thinner than the side wall side portion 50 is formed. The seal lip hard portion 51 is contactable with the door glass 4.

In the present sixth embodiment, the second vehicle inner seal lip 42 composed of the side wall side portion 50 and the seal lip hard portion 51 is formed over the entire length in the longitudinal direction of the third extrusion portion 13.

When the door glass 4 rises, in a region from a position slightly before the door glass 4 is closed to a position where it is completely closed, due to variations in the curvature of the door frame groove portion 6 (door frame 3) and the door glass 4, as illustrated in FIG. 8, a gap may occur between the vehicle outer hard portion 33 and the door glass 4.

In a region where a gap is generated between the vehicle outer hard portion 33 and the door glass 4, the door glass 4 is positioned further toward the vehicle inner side as compared with a region where the vehicle outer hard portion 33 and the door glass 4 are in contact. As a result, the first vehicle inner seal lip 41 and the second vehicle inner seal lip 42 both move toward the vehicle inner side wall, and the degree of deformation increases. At this time, the seal lip hard portion 51 formed in the second vehicle inner seal lip 42 comes into contact with the door glass 4 and the vehicle inner hard portion 48. Further, the side wall side portion 50 bends further toward the vehicle inner side based on the bend-base portion 52.

Even in regions other than those where a gap occurs between the vehicle outer hard portion 33 and the door glass 4, the seal lip hard portion 51 may come into contact with the vehicle inner hard portion 48.

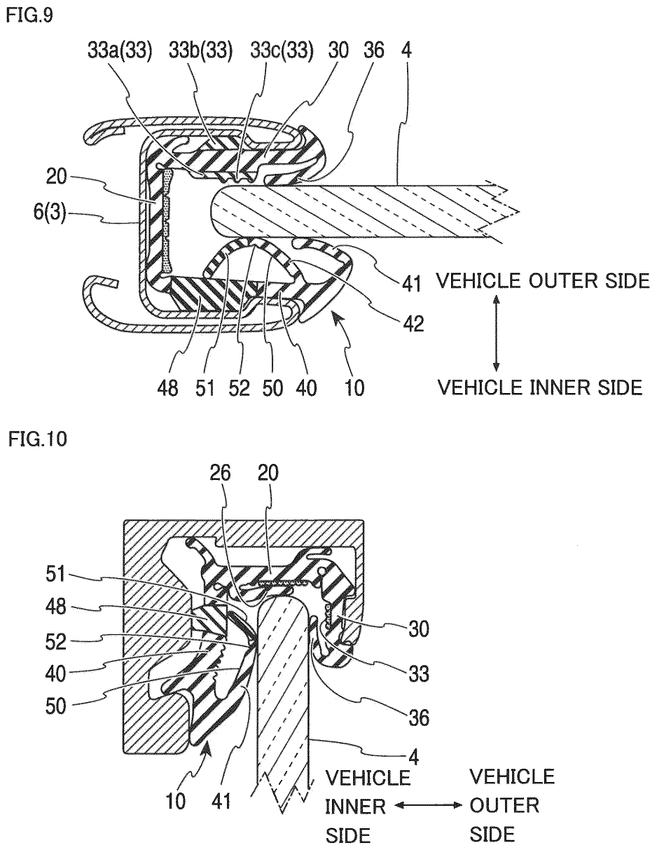

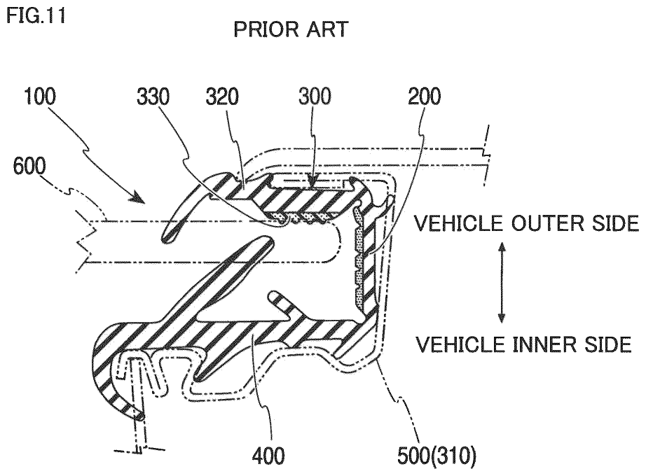

Next, a seventh embodiment of the present invention will be described with reference to FIG. 9. FIG. 9 is a sectional view taken along line B-B of FIG. 1 and illustrates a cross section when the glass run 10 is attached to the door frame groove portion 6 of the door frame 3 and the door glass 4 is closed. Further, this position corresponds to the second extrusion portion 12 in the vicinity of the first molded portion 14, which is a region where a gap occurs between the door glass 4 and a vehicle outer hard portion 33.

The differences between the present seventh embodiment and the above-described fourth embodiment are as follows. First, the seal lip side hard portion 49 is not formed. Second, the second vehicle inner seal lip 42 extends toward the vehicle outer side and the bottom wall 20 side, and a tip end portion is curved toward the vehicle inner side wall 40 side. Third, the second vehicle inner seal lip 42 is composed of the side wall side portion 50 connected to the vehicle inner side wall 40, and the seal lip hard portion 51 that is connected to the side wall side portion 50 and has a hardness higher than that of the side wall side portion 50. Fourth, on the vehicle inner side of the side wall side portion 50 in the vicinity of a connecting portion with the seal lip hard portion 51, a thin bend-base portion 52 thinner than the side wall side portion 50 is formed. The seal lip hard portion 51 is contactable with the door glass 4.

In a region where a gap is generated between the vehicle outer hard portion 33 and the door glass 4, the door glass 4 is positioned further toward the vehicle inner side as compared with a region where the vehicle outer hard portion 33 and the door glass 4 are in contact. As a result, the first vehicle inner seal lip 41 and the second vehicle inner seal lip 42 both move toward the vehicle inner side wall, and the degree of deformation increases. At this time, the seal lip hard portion 51 formed in the second vehicle inner seal lip 42 comes into contact with the door glass 4 and the vehicle inner hard portion 48. Further, the side wall side portion 50 bends further toward the vehicle inner side based on the bend-base portion 52.

Next, an eighth embodiment of the present invention will be described with reference to FIG. 10. FIG. 10 is a sectional view corresponding to the sectional view taken along line C-C of FIG. 1, and illustrates a cross section when the glass run 10 is attached to a mold having the same shape of the inner surface as the door frame groove portion 6 of the door frame 3, and the door glass 4 is closed. Further, this position corresponds to the first extrusion portion 11 in the vicinity of the first molded portion 14, and is a region where a gap is generated between the vehicle outer seal lip 36 and the vehicle outer hard portion 33.

The differences between the present eighth embodiment and the above-described fifth embodiment are as follows. First, the seal lip side hard portion 49 is not formed. Second, the first vehicle inner seal lip 41 extends toward the vehicle outer side and the bottom wall 20 side, and a tip end portion is curved toward the vehicle inner side wall 40 side. Third, the first vehicle inner seal lip 41 is composed of the side wall side portion 50 connected to the vehicle inner side wall 40, and the seal lip hard portion 51 that is connected to the side wall side portion 50 and has a hardness higher than that of the side wall side portion 50. Fourth, on the vehicle inner side of the side wall side portion 50 in the vicinity of a connecting portion with the seal lip hard portion 51, a thin bend-base portion 52 thinner than the side wall side portion 50 is formed. The seal lip hard portion 51 is contactable with the door glass 4.

In a region where a gap is generated between the vehicle outer hard portion 33 and the vehicle outer seal lip 36, the door glass 4 is positioned further toward the vehicle inner side as compared with a region where the vehicle outer hard portion 33 and the vehicle outer seal lip 36 are in contact. As a result, the first vehicle inner seal lip 41 moves in the vehicle inner side wall direction, and the degree of deformation increases. At this time, the seal lip hard portion 51 formed in the first vehicle inner seal lip 41 comes into contact with the door glass 4 and the vehicle inner hard portion 48. Further, the side wall side portion 50 bends further toward the vehicle inner side based on the bend-base portion 52.

As described in detail above, according to the embodiments of the present invention, the following effects can be obtained.
(1) In the first embodiment to the fourth embodiment described above, in a region where a gap is generated between the vehicle outer hard portion 33 and the door glass 4, since the door glass 4 is positioned on the vehicle inner side as compared with a region where the vehicle outer hard portion 33 and the door glass 4 are in contact, the first vehicle inner seal lip 41 and the second vehicle inner seal lip 42 both move in the vehicle inner side wall direction, and the degree of deformation increases. At this time, the seal lip side hard portion 49 formed on the vehicle inner hard portion 48 comes into contact with the first vehicle inner seal lip 41 or the second vehicle inner seal lip 42, and the first vehicle inner seal lip 41 or the second vehicle inner seal lip 42, the seal lip side hard portion 49, and the vehicle inner hard portion 48 are pressed to be sandwiched between the door glass 4 and the door frame groove portion 6. As a result, the rigidity between the first vehicle inner seal lip 41 or the second vehicle inner seal lip 42 and the vehicle inner hard portion 48 increases, and vibration of the door glass 4 can be propagated to the glass run 10 on the vehicle inner side of the door glass 4. Further, the vibration can be propagated to the door frame groove portion 6 to which the glass run 10 is attached. As a result, the effect of reducing the vibration by utilizing impedance matching can be sufficiently exhibited over the entire region of the glass run 10.
(2) In the fifth embodiment described above, in a region where a gap is generated between the vehicle outer seal lip 36 and the vehicle outer hard portion 33, since the door glass 4 is positioned on the vehicle inner side as compared with a region where the vehicle outer hard portion 33 and the vehicle outer seal lip 36 are in contact, the first vehicle inner seal lip 41 moves in the vehicle inner side wall 40 direction, and the degree of deformation increases. At this time, the seal lip side hard portion 49 formed on the vehicle inner hard portion 48 comes into contact with the first vehicle inner seal lip 41, and the first vehicle inner seal lip 41, the seal lip side hard portion 49, and the vehicle inner hard portion 48 are pressed to be sandwiched between the door glass 4 and the door frame groove portion 6. As a result, the rigidity between the first vehicle inner seal lip 41 and the vehicle inner hard portion 48 increases, and it becomes possible to propagate the vibration of the door glass 4 to the glass run 10 on the vehicle inner side of the door glass 4. Further, the vibration can be propagated to the door frame groove portion 6 to which the glass run 10 is attached. As a result, the effect of reducing the vibration by utilizing impedance matching can be sufficiently exhibited over the entire region of the glass run 10.
(3) In the sixth embodiment and the seventh embodiment described above, in a region where a gap is generated between the vehicle outer hard portion 33 and the door glass 4, since the door glass 4 is positioned on the vehicle inner side as compared with a region where the vehicle outer hard portion 33 and the door glass 4 are in contact, the first vehicle inner seal lip 41 and the second vehicle inner seal lip 42 both move in the vehicle inner side wall direction, and the degree of deformation increases. At this time, the seal lip hard portion 51 formed in the second vehicle inner seal lip 42 comes into contact with the door glass 4 and the vehicle inner hard portion 48. As a result, by impedance matching between the door glass 4 and the seal lip hard portion 51, it becomes possible to propagate the vibration of the door glass 4 to the glass run 10 on the vehicle inner side of the door glass 4. Further, the vibration can be propagated to the door frame groove portion 6 to which the glass run 10 is attached. As a result, the effect of reducing the vibration by utilizing impedance matching can be sufficiently exhibited over the entire region of the glass run 10.
(4) Further, since the thin bend-base portion 52 having a reduced thickness is formed on the vehicle inner side of the side wall side portion 50, the seal lip hard portion 51 comes into contact with the vehicle inner side wall 40 (vehicle inner hard portion 48). Furthermore, in a region where the door glass 4 is positioned on the vehicle inner side, the side wall side portion 50 becomes more likely to deform at the bend-base portion 52, making it possible to reduce the pressing force with which the seal lip hard portion 51 pushes the door glass 4 toward the vehicle outer side. As a result, it is possible to prevent any adverse effect on the sliding of the door glass 4.
(5) In the eighth embodiment described above, in a region where a gap is generated between the vehicle outer seal lip 36 and the vehicle outer hard portion 33, since the door glass 4 is positioned on the vehicle inner side as compared with a region where the vehicle outer seal lip 36 and the vehicle outer hard portion 33 are in contact, the first vehicle inner seal lip 41 moves in the vehicle inner side wall direction, and the degree of deformation increases. At this time, the seal lip hard portion 51 formed in the first vehicle inner seal lip 41 comes into contact with the door glass 4 and the vehicle inner hard portion 48. Further, the side wall side portion 50 bends further toward the vehicle inner side based on the bend-base portion 52. As a result, by impedance matching between the door glass 4 and the seal lip hard portion 51, it becomes possible to propagate the vibration of the door glass 4 to the glass run 10 on the vehicle inner side of the door glass 4. Further, the vibration can be propagated to the door frame groove portion 6 to which the glass run 10 is attached. As a result, the effect of reducing the vibration by utilizing impedance matching can be sufficiently exhibited over the entire region of the glass run 10.

The embodiment of the present invention is not limited to the above embodiment, and various modifications can be made without departing from the object of the present invention.

In the above embodiments, the door frame 3 having the door frame groove portion 6 has been described; however, the present invention can also be applied to the door frame 3 not provided with the door frame groove portion 6. In this case, for example, a vehicle outer cover lip extending toward the vehicle outer side and toward the bottom wall 20 side may be formed on the vehicle outer side wall 30, an outer frame may be inserted between the vehicle outer cover lip and the vehicle outer side wall 30 so that the outer frame comes into contact with the vehicle outer side wall 30 (or the vehicle outer hard portion 33), and an inner frame may be inserted between the vehicle inner side wall 40 and the vehicle inner cover lip 47 so that the inner frame comes into contact with the vehicle inner side wall 40 (or the vehicle inner hard portion 48).

In the first embodiment to the fifth embodiment described above, the seal lip side hard portion 49 is formed on the vehicle inner hard portion 48; however, it may alternatively be formed, by adhesion or molding, on the vehicle inner side surface of the first vehicle inner seal lip 41 or the second vehicle inner seal lip 42 that faces the vehicle inner hard portion 48.

What is claimed is:

1. A glass run comprising:
a bottom wall;
a vehicle outer side wall; and
a vehicle inner side wall, wherein a vehicle outer hard portion having a hardness higher than that of the vehicle outer side wall is formed on the vehicle outer side wall,
a vehicle inner hard portion having a hardness higher than that of the vehicle inner side wall is formed on the vehicle inner side wall,
a vehicle inner seal lip that extends toward the vehicle outer side and toward the bottom wall side and is in sliding contact with the door glass is formed on the vehicle inner side wall,
a seal lip side hard portion having a hardness higher than that of the vehicle inner seal lip is formed between the vehicle outer side of the vehicle inner side wall and the vehicle inner seal lip, on the vehicle inner side of the vehicle inner seal lip or on the vehicle outer side of the vehicle inner side wall,
in a case where the seal lip side hard portion is formed on the vehicle inner seal lip, the seal lip side hard portion is in contact with the vehicle inner side wall at least when the door glass is closed, and
in a case where the seal lip side hard portion is formed on the vehicle inner side wall, the seal lip side hard portion is in contact with the vehicle inner seal lip at least when the door glass is closed.

2. The glass run according to claim 1, wherein the hardness of the seal lip side hard portion is the same as that of the vehicle inner hard portion, or is between the hardness of the vehicle inner seal lip and that of the vehicle inner hard portion.

3. The glass run according to claim 1, wherein the seal lip side hard portion is formed in a region where, when the door glass is closed, the vehicle outer side of the door glass and the vehicle outer hard portion do not come into contact with each other, or,
in a case where a vehicle outer seal lip that extends toward the vehicle inner side and toward the bottom wall side and is in sliding contact with the door glass is formed on the vehicle outer side wall and the vehicle outer seal lip and the vehicle outer hard portion are contactable, the seal lip side hard portion is formed in a region where the vehicle outer seal lip and the vehicle outer hard portion do not come into contact with each other.

4. The glass run according to claim 3, wherein the seal lip side hard portion is formed by being attached to the vehicle inner seal lip or the vehicle inner side wall.

5. A glass run comprising:
a bottom wall;
a vehicle outer side wall; and
a vehicle inner side wall, wherein a vehicle outer hard portion having a hardness higher than that of the vehicle outer side wall is formed on the vehicle outer side wall,
a vehicle inner hard portion having a hardness higher than that of the vehicle inner side wall is formed on the vehicle inner side wall,
a vehicle inner seal lip that extends toward the vehicle outer side and toward the bottom wall side and has a tip end portion curved toward the vehicle inner side wall is formed on the vehicle inner side wall,
the vehicle inner seal lip includes a side wall side portion connected to the vehicle inner side wall and a seal lip hard portion having a hardness higher than that of the side wall side portion and connected to the side wall side portion, and
the seal lip hard portion is in contact with the door glass and the vehicle inner side wall at least when the door glass is closed.

6. The glass run according to claim 5, wherein the hardness of the seal lip hard portion is the same as that of the vehicle inner hard portion, or is between the hardness of the side wall side portion of the vehicle inner seal lip and that of the vehicle inner hard portion.

7. The glass run according to claim 5, wherein a thin bend-base portion having a reduced thickness is formed in the vicinity of a connecting portion between the seal lip side hard portion and the side wall side portion of the vehicle inner seal lip.

8. The glass run according to claim 7, wherein the bend-base portion is formed on the vehicle inner side of the side wall side portion.
